(19) United States
(12) Patent Application Publication
(10) Pub. No.: US 2020/0032085 A1
(43) Pub. Date: Jan. 30, 2020

(54) Modified Epoxy Resin Compositions for Additive Manufacturing

(71) Applicant: tri/REX, LLC, Austin, TX (US)

(72) Inventor: Kevin J. Hess, Austin, TX (US)

(21) Appl. No.: 16/524,906

(22) Filed: Jul. 29, 2019

Related U.S. Application Data
(60) Provisional application No. 62/711,441, filed on Jul. 27, 2018.

(51) Int. Cl. C09D 11/101; C09D 11/102; C09D 11/107; B33Y 70/00

(52) U.S. Cl. CPC C09D 11/101; B33Y 70/00; C09D 11/107; C09D 11/102

(57) ABSTRACT

Elastomer-modified epoxy liquid resin compositions curable by UV radiation for cationic polymerization, in some embodiments curable at or approximately at 355 nm, or at shorter wavelengths, and preferably for use with 2D-exposure systems (e.g., DLP systems), which may be used for additive manufacturing (AM) or 3D printing. The compositions are mixtures or blends of epoxy with elastomers reactive with epoxy, such as polyurethane or polyurea. The resins may include acrylates as a minor component. The resins may generally have a wt % of epoxy that cures, and a wt % of an elastomer that is functionalized to form reactive species, and include a wt % of photoinitiator that degrades and forms an acid catalyst (a photoacid generator). Cured mechanical and thermal properties of the compositions may exhibit improved elasticity, impact resistance, and/or flexural modulus, depending on the weight ratio of epoxy resin to polyurethane or polyurea in the blend.

### CROSS-REFERENCE TO RELATED APPLICATIONS

This application claims the benefit of U.S. Provisional Application No. 62/711,441, filed Jul. 27, 2019.

### FIELD OF THE INVENTION

The invention is generally related to light-curable, liquid resin compositions, and, more particularly, to liquid resin compositions having components curable with ultraviolet (UV) radiation by cationic polymerization (as opposed to free radical polymerization), and to liquid resin compositions having components curable with UV light by cationic polymerization as well as other components curable with UV light by free radical polymerization (i.e., “hybrid” resins).

### BACKGROUND

Many curable resin formulations currently exist for printing or coating applications, and for manufacturing or fabricating objects or products, such as by additive manufacturing (AM) or three-dimensional (3D) printing. As examples, epoxies have been used in photo-curing ink applications, and polyurethanes of varying composition have been used for hard and soft durometer applications. And, although some combination epoxy-polyurethane resin systems exist for use in AM or 3D printing processes, these systems print the epoxy component and cure the polyurethane component in a separate post-print, thermal process.

Some examples of current products include the following:
An acrylated epoxy system, EPX 82, offered by Carbon, Inc. for digital light processor (DLP) UV exposure, which cures at wavelengths longer than 355 nm.
An epoxy-acrylate hybrid resin, offered DSM Desotech Inc., for 355 nm laser-based stereolithography (SLA) processes.
Epoxy-based, UV-curable inks and coatings, offered by General Co., Ltd., for use in printing.

U.S. Pat. No. 9,982,164 ('164 patent), assigned to Carbon, Inc., describes resin compositions that include a photoinitiator and resin compatible with an initiator for printing 3D objects. A “latent” polyurea resin (i.e., which thermally cures in a post-printing curing step) includes two or more reactive components, which are inhibited from reacting with one another. In one example, a blocked isocyanate and an amine are provided. The isocyanate is prevented from reacting by a blocking agent. The blocking agent is dissociated thermally from the isocyanate group in a post-printing cure step, allowing the isocyanate group to react with the amine and form a urea group. The '164 patent discloses latent, dual cure resins, for example, at column 4, line 4 (C4:L4) of the '164 patent, the specification describes an epoxy-based, dual cure system that includes a latent polyurethane or polyurea. At C4:L33, the specification describes another dual cure system with a latent polyurethane or polyurea. And at C11:L36 to C13:L47, the specification broadly discloses “tougheners” or impact modifiers. Most of these materials disclosed are known impact modifiers that may be incorporated into the formulation and are compatible with acrylate and epoxy resins. Polyurethane and polyurea for use as tougheners, however, are not disclosed in the '164 patent.

Some possible disadvantages that the available UV-curable epoxy resins may exhibit include:
Forming brittle structures when cured in larger sections or thicknesses.
Not being impact-modified.
Not offering a phase-separated interpenetration polymer network (IPN) structure for improving impact resistance while maintaining mechanical rigidity.
Being formulated only for SLA, where a high irradiation level or flux is delivered very quickly by rastering a laser beam spot over the material. Such materials may have to include higher levels of initiator and/or photo sensitizer than would be needed in maskless projection, such as in DLP-based exposure processes.
Being sensitive only to UV light in the wavelength range of 365 nm to 405 nm. These materials generally have been based on acrylate functional or functionalized materials that are free radically polymerized by a radical generating photoinitiator when exposed to a specified irradiation dose from a modulated or controlled UV light source. Acrylate carbon-carbon double bonds, although they are very reactive and provide a curing speed useful for AM processes, may be somewhat less desirable for key material properties, such as impact resistance, heat distortion temperature (HDT), solvent resistance, or the like.

Therefore, it is desirable to provide materials that may exhibit none or less of the disadvantages described above. Moreover, certain embodiments of the present invention described below may improve over those disclosed in the '164 patent because they do not necessarily require a secondary post-printing cure unless post-curing of the matrix resin, epoxy in this case, is desirable.

### SUMMARY

None of the prior resin systems described above involve modifying an epoxy with an elastomer that includes a functionality reactive with the epoxy. In accordance with embodiments of the invention, however, elastomer-modified epoxy photocurable resins, which include but are not limited to elastomers such as polyurethane or polyurea, are disclosed. These embodiments may provide for desirable impact strength and thermal properties, while still reacting rapidly enough to be used in AM or 3D printing processes. Moreover, these embodiments may be used in DLP-based AM or 3D printing systems that employ UV light at 355 nm or approximately at 355 nm (approximately meaning, e.g., 355 nm±5 nm) or at shorter wavelengths. Such wavelengths may advantageously overlap desirable absorption (and photo curing) characteristics of the liquid resins disclosed herein. For example, these resins may offer the possibility that this overlap enables a less intense light source to be used to photocure them to a desired extent compared to the intensity required for other known resin systems that cure at longer wavelengths from the UV to the visible because these latter resins' absorption characteristics are weaker at these longer wavelengths. Thus, the exposure required to produce a rapid curing of the resin may be less at the shorter wavelengths than at the longer wavelengths.

In accordance with embodiments of the invention, the resins disclosed herein may also provide efficiency advantages to improve AM and/or 3D printing because they work well with low energy light sources, such as UV LEDs with output at 355 nm or at approximately at 355 nm.

In accordance with embodiments of the invention, cationic epoxy curing is disclosed that may provide additional advantages, such as: (1) initiation and propagation resistance to oxygen poisoning, which provides for extended (dark) curing; (2) reduced cure shrinkage over acrylates, which reduces warpage and internal stresses; and/or (3) reduced yellowing over acrylates due to the use of cationic photoinitiator systems. The use of a polyurethane-modified epoxy also may provide for an improved range of other properties, such as extending to lower flexural modulus, improved elasticity, and/or higher impact strength.

### BRIEF DESCRIPTION OF THE DRAWINGS

FIG. 1 illustrates a ternary diagram schematically showing possible mixtures or blends of epoxy(ies), elastomer(s), and acrylate(s) (which, if present, is (are) added as a minor component), where each vertex of the diagram represents one of the three components, in accordance with embodiments of the invention.

FIG. 2 illustrates a chemical formula for an oxetane-based monomer, where R1 represents a carrier structure, such as an aliphatic chain, aromatic ring, or other organic structure, in accordance with embodiments of the invention.

FIG. 3 illustrates a chemical formula for an oxirane-based monomer, where R1 represents a carrier structure, such as an aliphatic chain, aromatic ring, or other organic structure, in accordance with embodiments of the invention.

FIG. 4 illustrates a chemical formula for an oxetane-based crosslinking agent, where R2 represents a carrier structure, such as an aliphatic chain, aromatic ring, or other organic structure, in accordance with embodiments of the invention.

FIG. 5 illustrates a chemical formula for an oxirane-based crosslinking agent, where R2 represents a carrier structure, such as an aliphatic chain, aromatic ring, or other organic structure, in accordance with embodiments of the invention.

FIG. 6 illustrates a chemical formula for an oxetane-functionalized elastomer, where the “elastomer” block represents an oligomer or polymer, such as a polysiloxane, in accordance with embodiments of the invention.

FIG. 7 illustrates a chemical formula for an oxirane-functionalized elastomer, where the “elastomer” block represents an oligomer or polymer, such as a polysiloxane, in accordance with embodiments of the invention.

FIG. 8 illustrates a chemical formula for a photo acid generator, such as a diaryl iodonium salt, where R represents ring substitutions, such as amino groups, methyl groups, and/or hydroxyl groups, I⁺ represents a cation, such as an iodine cation, and X⁻ represents a counter anion, for example, hexafluorophosphate, in accordance with embodiments of the invention.

FIG. 9 illustrates a chemical formula for a photo sensitizer, such as thioxanthene, in accordance with embodiments of the invention.

### DETAILED DESCRIPTION

This application claims the benefit of U.S. Provisional Application Ser. No. 62/711,441, filed Jul. 27, 2019, which is incorporated herein by reference in its entirety.

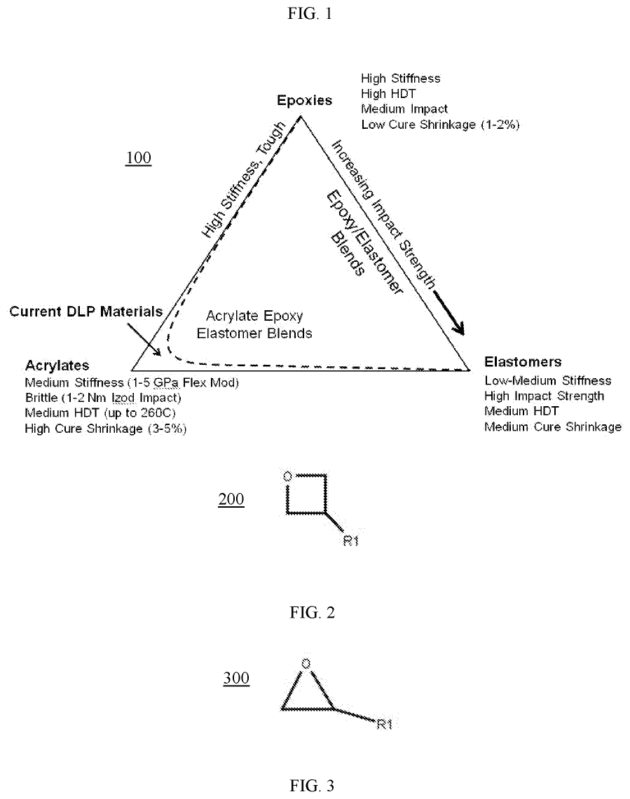

The material compositions described herein may comprise a mixture(s) or blend(s) of epoxy(ies) and an elastomer(s) (e.g., polyurethane, polyureas, or the like). In some embodiments, acrylate(s) is (are) added as a minor component(s), for example, at a wt % less than the wt % of the epoxy(ies) component(s) of the blend. The possible mixtures of these components are schematically depicted in a ternary diagram in FIG. 1, where each vertex of the diagram represents one of the components, and where each vertex has a legend that lists some of the physical properties or characteristics of each corresponding component. Material compositions along or toward the epoxy-elastomer edge may be advantageous because the properties of the blend may be improved over either single material component (e.g., because of a balance of stiffness, HDT, impact resistance, or the like).

In some embodiments, the resin compositions disclosed herein may be UV cured at a wavelength of 355 nm or approximately at 355 nm (e.g., 355 nm±5 nm) or at even shorter wavelengths in a digital light projection (DLP) system, optionally in conjunction with a process for 3D printing or additive manufacturing (AM). The compositions may be blends that involve mixing an epoxy (e.g., a monomer and/or oligomer) with an elastomer(s), such as polyurethane or polyurea resin(s). The resin(s) may not include an acrylate(s), but if included, the acrylate(s) would be a minor component added at up to about a 1:2 relative weight ratio to the epoxy(ies). For example, a composition may include about 1 gram of acrylate and about 2 grams of epoxy(ies), such that the acrylate comprises up to about 33% of the overall mass of the combination of the two resins. The resin(s) may have or generally (meaning ±2%) have 5-95 wt % epoxy(ies) that cure(s) and a complementary or corresponding 95-5 wt % polyurethane(s) or polyurea(s) that is (are) functionalized to form reactive species, taking into account 1-5 wt % of a photoinitiator(s) that is (are) also included that degrade(s) and forms an acid catalyst(s) (a photoacid generator(s) (PAG(s))). In general, the total wt % of these components (i.e., the wt % of epoxy monomer or oligomer, plus wt % of elastomer or impact modifier, plus wt % of any photoinitiator, plus wt % of other components, if present) add up to 100 wt % of the blend. Moreover, the wt % of the monomer or oligomer is the difference between 100 wt % of the blend and the sum of the wt % of the elastomer or impact modifier plus the wt % of the photoinitiator plus the wt % of any other components, if present, and similarly for the wt % of the elastomer or impact modifier, as would be understood by one of ordinary skill in the art. Cured mechanical and thermal properties of these compositions may exhibit improved elasticity, impact resistance, and flexural modulus, depending on the weight ratio of epoxy(ies) resin(s) to polyurethane(s) or polyurea(s) in the blend(s).

In accordance with embodiments of the invention, the material compositions disclosed herein may comprise monomer(s) with two reactive oxirane, glycidyl, or epoxide (strained ring) functionalities; optionally combined with dimers, trimers, or low molecular weight oligomers with similar strained ring functionalities; a crosslinking agent with strained ring functionality >2; a property (e.g., impact resistance)-modifying resin comprising a polyurethane resin or a polyurea resin; a cationic photoinitiator sensitive to irradiation with wavelengths centered at 355 nm (or approximately (as above) at 355 nm) or centered at even a shorter wavelength (or approximately (e.g., ±5 nm) about that shorter wavelength), and, optionally, a photosensitizing agent absorbing at wavelengths longer than 355 nm (or longer than the center wavelength used for photocuring), such as at or approximately at 383 nm, depending on the photosensitizer used.

Exemplary Embodiments of the Resin Compositions:

In a liquid resin, A and D below are included and C and E are optional:
A. a monomer and/or an oligomer, such as an epoxy, glycidyl, oxetane resin or glycidyl-functional aliphatic or aromatic groups, vinyl esters, vinyl ethers, heterocyclic monomers (including lactones, lactams, and cyclic amines) such as oxirane, thietane, tetrahydrofuran, oxazoline, 1,3, dioxepane, oxetan-2-one, etc., and/or combinations thereof (e.g., at 50-80 wt % inclusive);
B. optionally, a crosslinking agent, such as a monomer and/or an oligomer different than the A component(s), with two or more functional groups that are compatible to react with the A components, such as a triglycidyl aromatic crosslinking agent or the like (e.g., at 1-20 wt % inclusive);
C. an impact modifier, such as a functionalized elastomer, rubber, or other resin, wherein the functional groups are compatible to react with the monomer. Non-limiting examples include silicones, siloxanes, polyureas and polyurethanes. For example, a polyurethane comprising the product of an aromatic diisocyanate, a diol chain extender, and a functionalizing agent, such as a glycidyl functional amine, silanol, or carbamate may be used (e.g., at 1-10 wt % inclusive);
D. a suitable (generally ionic or non-ionic) photoacid generator (PAG), examples of which include, but are not limited to onium salts, sulfonium and iodonium salts, etc., the PAG capable of interacting with UV wavelengths to form an acid catalyst (e.g., at 0.1-5 wt % inclusive);
E. a photosensitizer, capable of absorbing energy at UV wavelengths longer than the photoinitiator, such as thioxanthenes, or the like (e.g., at 0.1-5 wt %);
F. optionally, solid particles suspended or dispersed in the resin, for example particles that are metallic, organic/polymeric, inorganic, or composites or mixtures thereof. Exemplary particles include boron nitride, aluminum nitride (may be used in AM since there is no mold that would degrade from exposure to such materials) or other similar aluminum oxides, glass, fused silica, graphene, carbon nanotubes, or the like. The particles may be nonconductive, semi-conductive, or conductive (e.g., including metallic, non-metallic, or polymer conductors); and the particles may be magnetic, ferromagnetic, paramagnetic, or nonmagnetic. The particles may be of any suitable shape, including angularly formed, randomly shaped, flakes, spherical, vol % mixtures of flakes and spheres, elliptical, cylindrical, etc. The particles may have any useful aspect ratio (length to diameter or width), including, for example, 1:1 to 100:1 or higher. The particles may be of any suitable size (e.g., ranging from 1 nm to 100 um average diameter inclusive). Further, the size distribution of the particles may be monodisperse or unimodal, bimodal, polydisperse, or comprise a continuous distribution of particle size (from, e.g., 1-30 wt % inclusive based on the resin composition A-E).
G. optionally, pigments, dyes, active compounds may be suspended or solubilized in the liquid resin, and/or tracer or detectable compounds (e.g., fluorescent, phosphorescent, radioactive, or the like), may be incorporated, or including any combinations thereof.

The mechanical properties of the above composition(s) may be adjusted by changing the ratios of: (1) A:B (base resin crosslink density); (2) AB:C (impact modification, elasticity); and/or (3) ABC:F (flexural rigidity and thermal resistance), for example, to yield a flexural modulus in the range 1-80 GPa inclusive, Heat Distortion Temperature (HDT) in the range 23-280 C inclusive, Impact Strength in the range 0.05-2.0 J/mm inclusive or 1-50 Nm inclusive, if normalized for impact test sample dimensions.

The use of cationic epoxy curing may offer additional benefits, such as: (1) initiation and propagation being resistant to oxygen poisoning, which provides for extended curing after UV radiation exposure, sometimes called “dark” curing; (2) reduced cure shrinkage over acrylates, which reduces warpage and internal stresses; and/or (3) reduced yellowing over acrylates, the reduction resulting from the use of cationic photoinitiator systems.

Specific Exemplary Embodiments of the A-G Components Above for the Resin Compositions:
A. Diglycidyl ether bisphenol A (DGEBA), aliphatic oligomers of glycidyl ether; cycloaliphatic ring epoxides (3,4,-epoxycyclohexylmethyl-3,4-epoxycyclohexame carboxylate); 2-ethyl-2-hydroxymethyl oxetane.
B. Low molecular weight glycidyl methacrylate oligomers, trimers; triglycidyl-p-aminophenol; N,N,N,N-tetraglycidyl-4,4-methylenebis benzylamine.
C. Polyurethane component formed by reacting toluene diisocyanate (TDI) with diol chain extender, such as ethylene-1,2-diol, leaving excess iso functionality to be terminated with a glycidyl amine. In another embodiment, a polyurea component may be formed by reactive methylene diisocyanate (MDI) with a polyether amine or a short chain diamine, leaving excess isocyanate functionality to be terminated with a glycidyl amine.
D. Iodonium salt catalyst, such as Ciba Specialty Chemicals Irgacure 250; triarylsulphonium salts, such as Dow Cyracure UVI-6976, Cyracure UVI-6992; Degussa Degacure K185; or other sulphonium salts, for example, Quang Li Chem QL Cure 211 and/or QL Cure 212, Asahi Denka SP-150, IGM Omnicat 550, and Ciba Irgacure MacroCAT.
E. Thioxanthone (ITX), such as Lambson Speedcure ITX (a mixture of 2-isopropylthioxanthone and 4-isopropylthioxanthone), or Speedcure 2-ITX (2-isopropylthioxanthone).
F. Nanoclays, such as montmorillonite; glass spheres; short glass fibers; graphene; carbon fiber; carbon nanotubes, tungsten, mica, and/or rutile. In some embodiments, these additives may be surface treated with an amino or a glycidyl functional silane or titanate to improve the chemical bonding at the resin-filler interface.
G. Pigments, such as titanium dioxide white, magenta, cyan, and yellow may be used, in which case, the addition of a photosensitizer E may be beneficial for curing the resin.

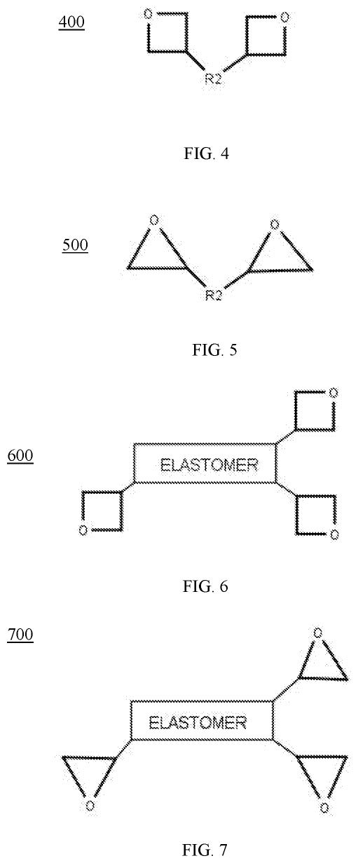

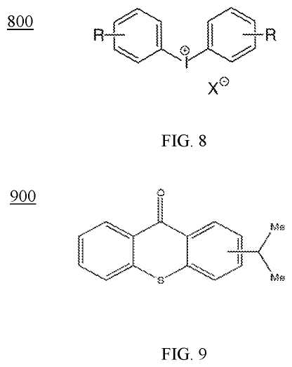

Exemplary Chemical Structure Embodiments for the A-G Components Above of the Resin Compositions:
A. Oxetane-based monomer 200 (FIG. 2) and oxirane-based monomer 300 (FIG. 3), where R1 represents a carrier structure, such as an aliphatic chain, aromatic ring, or other organic structure.
B. Oxetane-based crosslinking agent 400 (FIG. 4) and an oxirane-based crosslinking agent 500 (FIG. 5), where R2 represents a carrier structure, such as an aliphatic chain, aromatic ring, or other organic structure.
C. Oxetane-functionalized elastomer 600 (FIG. 6) and oxirane-functionalized elastomer 700 (FIG. 7), where the “elastomer” block represents an oligomer or polymer, such as a polysiloxane.
D. Photo acid generator 800 (FIG. 8), such as a diaryl iodonium salt, where R represents ring substitutions, such as amino groups, methyl groups, hydroxyl groups, for example, I⁺ is an iodine cation (for example, an iodonium cation), and X⁻ is a counter anion (for example, an hexafluorophosphate anion). An example photoacid generator is BASF Irgacure 250, where the R groups are methylene and sec-butylene groups and the counter anion is phosphorous hexafluoride.
E. Thioxanthene photo sensitizer 900 (FIG. 9), such as thioxanthene, for example, Speedcure ITX.

Exemplary Tested Liquid Resin Blends to which Impact Modifiers, Such as Polyurethane or Polyurea, May be Added for Further Testing:

### Example 1

Cationically curable compositions were blended and irradiated, using a broad band UV light source, to evaluate the degree of cure and mechanical properties, as described herein. UV irradiation was provided from a full spectrum metal halide bulb, such as the “D” bulb used in a Nordson CoolWave® system, emitting UVA wavelengths generally between 350 nm and 390 nm and fitted with a filter to block wavelengths outside of the range of 320 nm to 500 nm, inclusive. A blend was formed using equal parts of three monomers: (1) 31.7 wt % Bisphenol A Epoxy (CVC Emerald Epalloy 7192); (2) 31.7 wt % 3,4-Epoxycyclohexylmethyl 3,4-Epoxycyclohexanecarboxylate (Synasia S-06E); and (3) 31.7 wt % 2-(3-Oxetanyl)-1-Butanol (Tronly TCM-101). These were blended with (4) 3.9 wt % Triarylsulfonium Hexafluoroantimonate (Omnicat 320) and 1 wt % Polyether Modified Polydimethylsiloxane (Byk 333). This blended resin/initiator system was poured into a glass-bottomed tray for printing. A photomask was placed on the glass exposure window of the resin tray. Openings in the photomask were sized to generate bar-shaped coupons of cured resin with dimensions sufficient to prepare mechanical test samples. The resin mixture was cured by exposing the liquid through the mask openings using a high-intensity broadband UV irradiation source to form a cured resin thickness of approximately 0.8 millimeters. After photocuring, the sample bars were post-cured for two hours at 150 C. The cured resins were tested to evaluate tensile and flexural properties.

Tensile testing was performed on a Test Resources Tensile Test Machine (Model: 100-P-500-12) in accordance with the ASTM D638-IV standard with a strain rate of 10 mm/min. The test samples measured 6 millimeters in width and approximately 0.8 millimeters in thickness with a gauge length of approximately 35 millimeters. Due to slight variations in the width and thickness of each sample, these dimensions were measured individually, and the individual measurements were used in the calculations of the material properties.

Flexural testing was performed on a Test Resources Tensile Test Machine (Model: 100-P-500-12) outfitted with a three-point bend set-up in accordance with the ASTM D790 standard with a crosshead speed of 1 millimeter/minute. The test samples measured 25 millimeters in length and 2.2 millimeters in width, with a thickness of 2 millimeters. Due to slight variations in the width and thickness of each sample, these dimensions were measured individually, and the individual measurements were used in the calculations of the material properties. The mechanical properties of the cured Example 1 liquid resin were determined to be as follows:

Tensile Modulus: 730+/−44 MPa

Tensile Strength: 46+/−2 MPa

Tensile Elongation: 6+/−1%

Flexural Modulus: 3100+/−400 MPa

Flexural Strength: 120+/−25 MPa

Flexural Elongation: 12+/−4%

### Example 2

Cationically curable compositions were blended and irradiated to evaluate the degree of cure and mechanical properties, as described herein. A blend was formed using equal parts of three monomers: (1) 31.7 wt % Di-epoxidized Hydrogenated Bisphenol A (CVC Emerald Epalloy 5000); (2) 31.7 wt % 3,4-Epoxycyclohexylmethyl 3,4-Epoxycyclohexanecarboxylate (Synasia S-06E), and (3) 31.7 wt % 2-(3-Oxetanyl)-1-Butanol (Tronly TCM-101). These were blended with 3.8 wt % (4) Triarylsulfonium Hexafluoroantimonate (Omnicat 320) and 1 wt % Polyether Modified Polydimethylsiloxane (Byk 333). The Example 2 resin was cured, prepared into mechanical test specimens, and tested as outlined above for Example 1, with results as follows:

Tensile Modulus: 760+/−4 MPa

Tensile Strength: 40+/−1 MPa

Tensile Elongation: 6+/−1%

Flexural Modulus: 2400+/−690 MPa

Flexural Strength: 110+/−4 MPa

Flexural Elongation: 11+/−1%

### Example 3

Cationically curable compositions were blended and irradiated to evaluate the degree of cure and mechanical properties. A blend of three monomers: (1) 19 wt % Di-epoxidized Hydrogenated Bisphenol A (CVC Emerald Epalloy 5000); (2) 57.2 wt % 3,4-Epoxycyclohexylmethyl 3,4-Epoxycyclohexanecarboxylate (Synasia S-06E); and (3) 19 wt % 2-(3-Oxetanyl)-1-Butanol (Tronly TCM-101). These were blended with 3.8 wt % (4) Triarylsulfonium Hexafluoroantimonate (Omnicat 320) and 1 wt % (5) Polyether Modified Polydimethylsiloxane (Byk 333). The Example 3 resin was cured, prepared into mechanical test specimens, and tested as outlined above for Example 1, with results as follows:

Tensile Modulus: 770+/−100 MPa

Tensile Strength: 32+/−15 MPa

Tensile Elongation: 5+/−1%

Flexural Modulus: 2500+/−63 MPa

Flexural Strength: 130+/−10 MPa

Flexural Elongation: 10+/−1%

These three exemplary tested liquid resin embodiments disclosed above may be further tested for impact modification by adding impact modifiers, including, but not limited to, elastomers such as polyurethane, polyurea, or the like, as disclosed herein.

In accordance with embodiments of the invention, the proposed materials may be photocured in an AM or 3D printing system that provides a 355 nm UV digital light source (e.g., LED- or laser-based) or another type of 355 nm UV light source (e.g., a wavelength-filtered analog source). It is contemplated that in some embodiments, the materials compositions described herein may cure well within a range of or at specific UV wavelengths, for example, centered at a wavelength in the range from, for example, 355 nm±5 nm down to 310 nm±5 nm, by appropriately adjusting or changing the cationic photo initiators.

In accordance with embodiments of the invention, depending on the formulation, the epoxy/polyurethane or epoxy/polyurea materials disclosed herein may be used in AM or 3D printing for the production of structural and engineering components, such as solid structures in which impact strength, flex modulus, and thermal resistance are at desirable, good, or high levels or values, for examples, at levels or values that are better than or at least similar to current materials. With adjustments to the material compositions, the materials described herein may be used, for example, to form elastomeric structures with high elongation for impact cushioning.

The proposed liquid resin formulations disclosed herein may be manufactured using processes and methods for formulation in the industry, such as mixing, blending, compounding, dissolving, suspending, and degassing operations. Depending on the material formulation, synthesis of a functionalized polyurethane or polyurea adduct may be required. As a non-limiting example, a reaction of TDI with an excess of an aliphatic diamine may be carried out to form a product with terminal amine groups. The terminal amine groups of the first product may be further reacted with an excess of a diglycidyl cycloaliphatic monomer to terminate the TDI-diamine adduct with a glycidyl functionality, thus forming a glycidyl functional polyurea.

The specific embodiments disclosed herein are merely exemplary, and it should be understood that within the scope of the appended claims, the invention may be practiced in a manner or manners other than those specifically described in these embodiments. Specifically, it should be understood that the claims are not intended to be limited to the particular embodiments or forms disclosed, but rather to cover all modifications, equivalents, and alternatives falling within the spirit and scope of this disclosure. Also, any structures, components, or process parameters, or sequences of steps disclosed and/or illustrated herein are given by way of example only and may be varied as desired. For example, for any steps illustrated and/or described herein that are shown or discussed in a particular order, these steps do not necessarily need to be performed in the order illustrated or discussed. Further, the various exemplary structures, components, or methods described and/or illustrated herein may also omit one or more structures, components, or steps described or illustrated herein or include additional structures, components, or steps in addition to those disclosed.

1. A radiation curable composition, comprising a mixture of:
a monomer, having a cationically curable functionality;
an elastomer having a cationically curable functionality; and
a photoinitiator.

2. The composition of claim 1, wherein the elastomer comprises polyurethane.

3. The composition of claim 1, wherein the elastomer comprises polyurea.

4. The composition of claim 1, further comprising acrylate.

5. A composition useful for the production of a three-dimensional object by additive manufacturing, the composition comprising:
a monomer, having a cationically curable functionality;
an elastomer having a cationically curable functionality; and
a cationic photoinitiator.

6. The composition of claim 5, wherein the monomer comprises epoxy.

7. The composition of claim 5, wherein the elastomer is configured to be reactive with the monomer.

8. The composition of claim 5, wherein the elastomer comprises polyurethane.

9. The composition of claim 5, wherein the elastomer comprises polyurea.

10. The composition of claim 5, further comprising an acrylate.

11. A radiation curable composition, comprising:
a first wt % of monomer or oligomer;
a second wt % of a cationically curable component different than the monomer or oligomer; a third wt % of a cationic photoinitiator; and
wherein the first wt % is the difference between 100 wt % and the sum of the second wt % and the third wt % and the second wt % is the difference between 100 wt % and the sum of the first wt % and the third wt %, such that the wt % of the composition totals 100 wt %.

12. The composition of claim 11, wherein the cationically curable component comprises an impact modifier.

13. The composition of claim 11, wherein the cationically curable component comprises an elastomer.

14. The composition of claim 13, wherein the elastomer comprises polyurethane.

15. The composition of claim 13, wherein the elastomer comprises polyurea.
